(19) United States
(12) Patent Application Publication
(10) Pub. No.: US 2007/0162315 A1
(43) Pub. Date: Jul. 12, 2007

(54) SPACE RESERVATION SYSTEM

(75) Inventor: Stephen E. Hodges, Cambridge (GB)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/275,474

(22) Filed: Jan. 6, 2006

(51) Int. Cl. G05B 19/418

(52) U.S. Cl. 705/8

(57) ABSTRACT

The invention is directed to a space reservation system that has the ability to receive occupancy information relating to a space. The occupancy information originates from a sensor. The invention is also directed to an occupancy sensing apparatus for a space reservation system. The sensing apparatus includes a sensor and a processor that determines from the data from the sensor whether the space is occupied. This information can then be sent to a space reservation system. The invention is also directed to a method of reserving a space in which the occupancy of the space is detected and if the space is occupied, a reservation is made for the space for a period of time.

### BACKGROUND

Most organizations have a number of meeting rooms and in order to manage the use of these rooms, booking systems are usually required to enable users to reserve rooms in advance. Traditionally such booking systems comprised a paper diary located in or near the meeting room.

Recently electronic booking systems have been developed, such as the facility integrated within Microsoft® Outlook®. Such a system provides a central booking facility that can be accessed by users from their desks via their computers. Using Microsoft® Outlook® a room can be booked for a meeting by adding the resource of the required room to the meeting invitation. The meeting invitation is accepted by the room resource if the room is free and then entered in the room's calendar. If the room is not free, the meeting invitation is automatically rejected.

A problem with such networked computer based booking systems is that they do not accommodate impromptu meetings, which may be held in an empty meeting room at short notice and without someone returning to a computer to reserve the room. Such meetings occupy rooms that appear available according to the electronic booking system and hence conflicts between users can occur.

This problem is addressed to an extent by RoomWizard® from Steelcase®. RoomWizard® provides touchscreens that can be located outside meeting rooms. These screens allow a user to see whether a meeting room is available or booked (using red and green lights) and also enable a user to make an instant reservation of an available meeting room by touching the screen, without the need to return to a networked computer.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A space reservation system may have the ability to receive occupancy information relating to a space. The occupancy information originates from a sensor that may be located in the space. As used herein, occupancy information includes determining that live bodies, such as humans, animals, and the like are present in the space.

An occupancy sensing apparatus may be included in the space reservation system. The sensing apparatus includes a sensor and a processor that determines from the data from the sensor whether the space is occupied. This information can then be sent to a space reservation system.

A method may be provided for reserving a space in which the occupancy of the space is detected and if the room is occupied, a reservation is made for the space for a period of time.

Use of occupancy information has an advantage that reservations can be made by the reservation system when a space or room is or becomes occupied. This has the effect that other potential users of the space or room are made aware that the space is no longer available for use and this prevents conflicts between meetings and users of the space.

The methods described may be performed by software in machine readable form on a storage medium or by firmware that can be stored in memory and run in embedded systems.

This acknowledges that software and firmware can be valuable, separately tradable commodities. It is intended to encompass software, which runs on or controls “dumb” or standard hardware, to carry out the desired functions, (and therefore the software essentially defines the functions of the register, and can therefore be termed a register, even before it is combined with its standard hardware). For similar reasons, it is also intended to encompass software which “describes” or defines the configuration of hardware, such as HDL (hardware description language) software, as is used for designing silicon chips, or for configuring universal programmable chips, to carry out desired functions.

The features described herein may be combined as appropriate, as would be apparent to a skilled person, and may be combined with any of the aspects described.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a meeting room reservation system;

FIG. 2 is an example flow diagram showing the operation of the arrangement of FIG. 1;

FIG. 3 is a schematic diagram of a second meeting room reservation system;

FIG. 4 is a schematic diagram of a third meeting room reservation system;

FIG. 5 is an example flow diagram showing the operation of the arrangement of FIG. 4;

FIG. 6 is a schematic diagram of a fourth meeting room reservation system;

FIG. 7 is a schematic diagram of a meeting room layout; and

FIG. 8 is a schematic diagram of a second meeting room layout.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

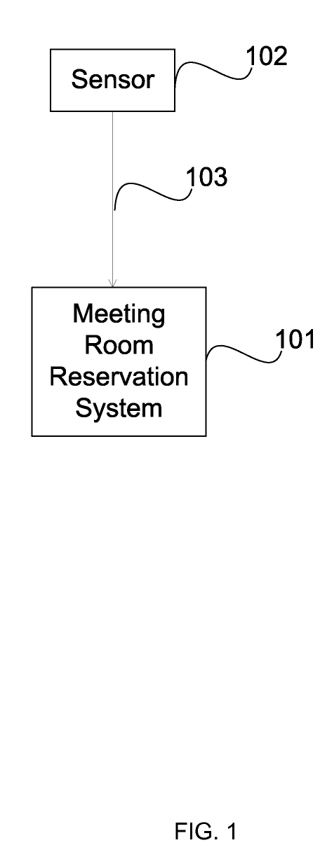

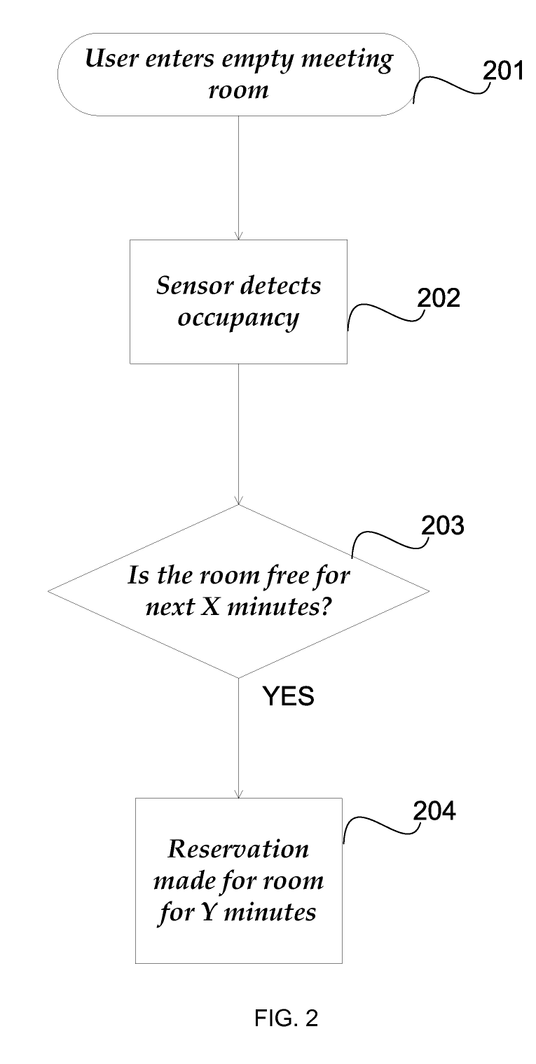

A first embodiment can be described with reference to FIGS. 1 and 2. FIG. 1 shows meeting room reservation system 101 which can receive input from a sensor 102 over a connection 103. The meeting room reservation system 101 may be, by way of example only, a Microsoft® Outlook® system or the RoomWizard® system from Steelcase®. The sensor 102 is located inside a meeting room controlled via the reservation system 101 and may be any sensing apparatus which can be used to sense whether the meeting room is occupied or not, for example a PIR (passive infrared) sensor. Examples of suitable sensors include motion, sound, temperature, heat, pressure and vibration sensors. Further examples of suitable sensors are provided in the following description and it will be apparent to a skilled person that they may be used in any embodiment. The connection 103 between the sensor 102 and the meeting room reservation system 101 is a logical connection only. The connection may be indirect (e.g. across a LAN, VPN or the internet) and may be via a physical link (such as a wire), via a wireless link or via a combination of the two.

Many meeting rooms include a lighting system with sensors to detect movement so that the lights can be turned off when the room is unoccupied. The sensor 102 may be an existing sensor in the meeting room, with the sensor output signal being used for an additional purpose.

When a user enters the meeting room where the sensor 102 is located (step 201, FIG. 2), the sensor detects that the room is now occupied (step 202). A signal is sent via connection 103 to the meeting room reservation system 101. This signal may be the raw sensor output or may be a processed signal that indicates a state of occupancy of the meeting room. On receipt of the signal, the meeting room reservation system checks whether the meeting room is free for a specified period of time, X minutes (step 203) where the value of X may be set by the owner of the meeting room reservation system or may be a fixed value. An example value is 15 minutes. If the room is free, i.e. not already reserved in the meeting room reservation system, then the meeting room reservation system makes a new reservation for the next Y minutes (step 204), where Y may be less than or equal to X.

If the meeting room is found not to be available for X minutes (in step 203) but only free for X−5 minutes, the meeting reservation system 101 may still be able to make an automatic reservation but only for Y=X−5 minutes.

By making such an automatic reservation when a meeting room is occupied for an impromptu meeting, other potential users of the meeting room are made aware that the room is no longer available for use and this prevents conflicts between meetings and users of the room.

When making such an automatic reservation, the meeting room reservation system 101 may identify the reservation as an automatic reservation rather than an advance reservation. This may be beneficial if a room is required at short notice for an important meeting and a decision needs to made as to which existing meeting needs to be interrupted so that a room can be found for the important meeting. An impromptu meeting may be considered of lower importance than a pre-arranged meeting (i.e. a meeting where a reservation is made in advance).

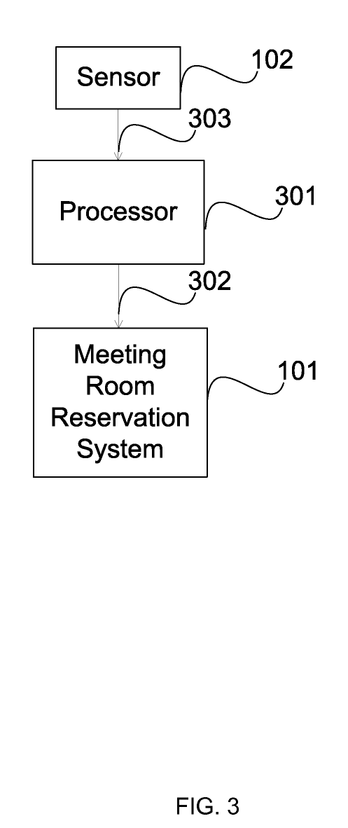

A second embodiment is shown in FIG. 3, which shows a meeting room reservation system 101 that can receive input from a sensor 102. The raw data output of the sensor 102 is received by a processor 301 where the output is processed to produce an occupancy signal which is then input into the meeting room reservation system 101. The occupancy signal indicates the current state of occupancy, e.g. empty or occupied, or alternatively the occupancy signal may indicate a change in state of occupancy e.g. from empty to occupied or vice versa.

The processor 301 may comprise an embedded microcontroller. The processor 301 runs an algorithm on the raw sensor data to determine, with a reasonable level of confidence, if the room is occupied. This algorithm may require, for example, the consistent detection of occupancy for a specified length of time, typically somewhere between 5 seconds and 5 minutes. Specifying a length of time of a few minutes may prevent erroneous reservations being made as a result of a user briefly entering a room, for example to retrieve an item such as a forgotten notebook or to borrow a chair. Whilst specifying a shorter length of time minimizes the time when conflicts can occur, after the impromptu meeting has started but before the meeting room reservation system has made the automatic reservation.

In FIG. 3 the processor 301 is shown as a separate box from the sensor 102 and the meeting room reservation system 101. These boxes (and those in FIGS. 1, 4 and 6) indicate functional entities and not necessarily physical entities. The processor may be a separate unit or may be co-located with either the sensor 102 or the meeting room reservation system 101.

By integrating the sensor 102 and the processor 301 into a single unit the link 303 carrying the raw data becomes internal to the unit. Consequently the signaling over the longer link (link 302 between the processor and the meeting room reservation system 101) may be minimized because only status information and not raw data is transmitted over this link. Such an integrated sensor-processor unit may comprise the sensor, the processor, a network card and a power supply.

By integrating the processor's function 301 into the meeting room reservation system 101, the processing capability may be shared between several sensors which may be located in several rooms, but the raw sensor data needs to be sent over link 303 which may be quite long, (link 302 will be the short internal link).

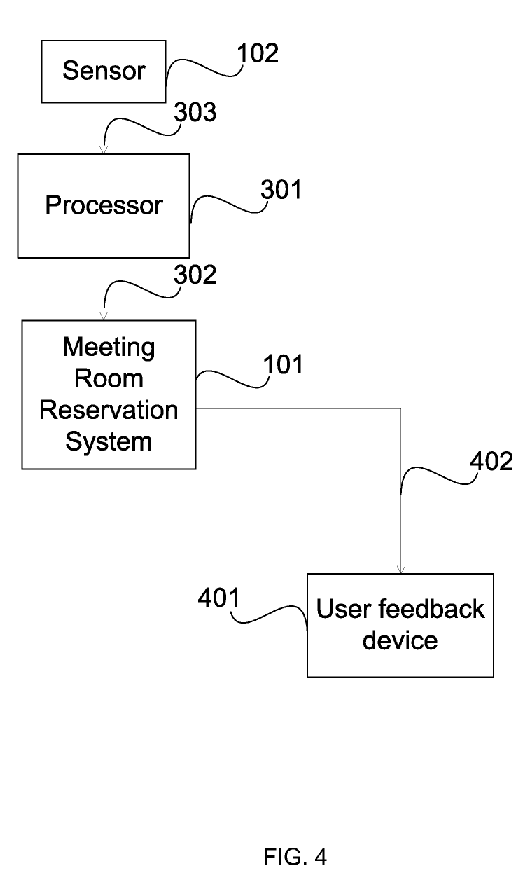

A third embodiment is shown in FIG. 4, which shows the same arrangement as the second embodiment with the addition of a user feedback device 401 that is connected to either the meeting room reservation system 101 (via link 402) or to the processor 301 (link not shown). The direction of the linking arrows in FIG. 4 (and also in FIGS. 1, 3 and 6) indicate the main direction of flow of information but not that these links are necessarily unidirectional.

The user feedback device 401 may be a buzzer, bell, speaker or other device capable of providing audible feedback to the user in the meeting room, where the feedback may be a simple alarm sound or a verbal warning message. Alternatively the feedback device 401 may be a light, screen or other device capable of providing visual feedback to the user. In an example, a visual feedback device may be integrated with a projector or computer in the room such that a feedback message may be flashed onto the screen when required. The user feedback device 401 is not necessarily located in the meeting room but capable of providing feedback to the user in the meeting room. Alternatively, the user feedback device may not be a physical apparatus but a functional element that may be separate to or integrated with the meeting room reservation system 101. For example, the user feedback device may be arranged to send a message to a user's mobile phone, computer (e.g. laptop or tablet) or PDA via SMS (short message service), email, Instant Messenger (IM) or Bluetooth. Other examples of suitable feedback devices are detailed below.

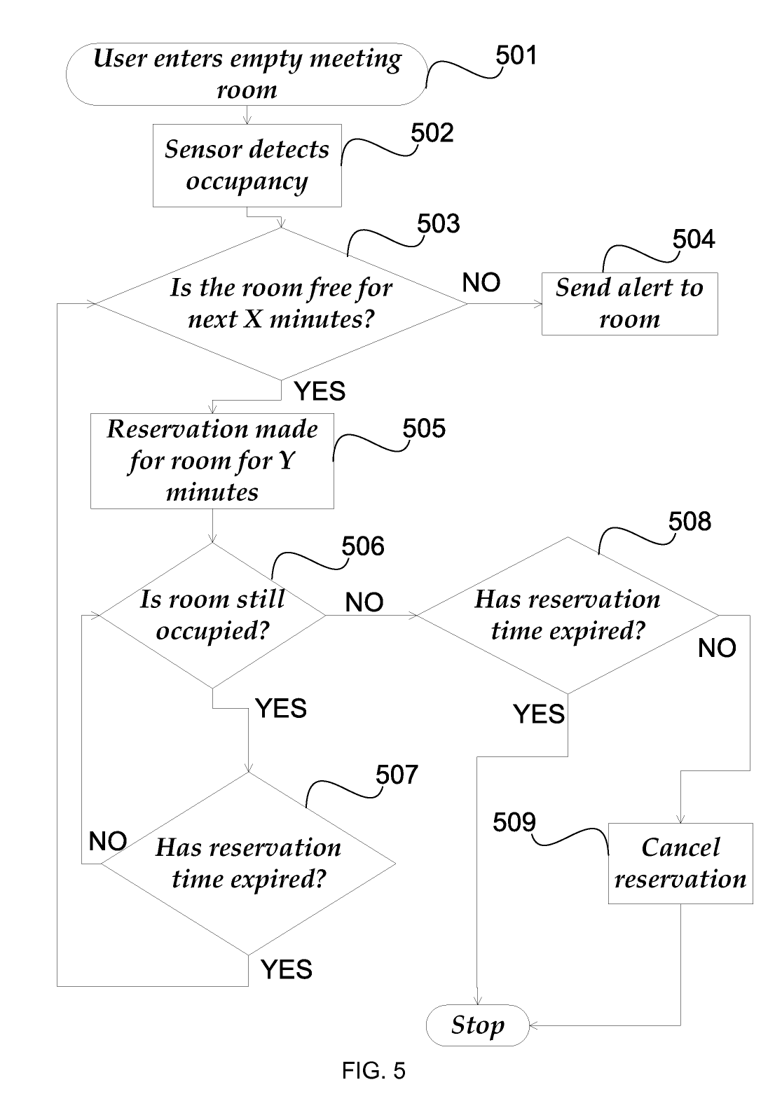

An example flow diagram showing the operation of the arrangement of FIG. 4 is shown in FIG. 5. When a user enters an empty meeting room to hold an impromptu meeting (step 501), the sensor 102 detects that the status of the room has changed from empty to occupied (step 502). This is signaled to the meeting room reservation system 101, which checks whether the meeting room in question is available for the next X minutes (step 503), where an example value of X is 15.

If the meeting room is not free, because there is a pre-existing reservation in the reservation system within the next X minutes, an alert is sent to the room (step 504) and the user(s) are warned via the user feedback device 401 that they will shortly be interrupted for a pre-booked meeting. If however, the room is free for the next X minutes, a reservation may be made in the meeting room reservation system 101 for this period of time (step 505, where Y=X in this exam pie).

After Z minutes (where Z is less than or equal to Y, but typically a small value such as 3), the occupancy status of the room is checked (step 506). This check may be performed on a continuous basis (where Z has a finite value which is approaching zero) and may be performed by the processor 301 or the meeting room reservation system 101. If the room is still occupied, the meeting room reservation system checks whether the X minute reservation made earlier (in step 505) has expired (step 507). If the reservation has not yet expired, the occupancy status will be re-checked after Z minutes (step 506). If the reservation has expired, a new reservation is required (step 505) and the meeting room system first checks whether the room is free for the next X minutes (step 503) and if not warns the occupants of the meeting room (step 504).

If at the occupancy check (step 506) the room is found to be empty, the meeting room reservation system 101 checks whether the X minute reservation made earlier (in step 505) has expired (step 508) and if not cancels the remaining time in the reservation (step 509). This step is not required if the reservation has already expired. The reservation system is therefore left showing that the meeting room is available for use and the process would start again (with step 501) on entry of a user to the empty meeting room.

It will be apparent to a skilled person that the flow diagram of FIG. 5 could also show an example operation of the first and second embodiments, with the omission of step 504.

The user feedback device 401 is described above as providing the occupants of the meeting room with an alert or warning if an automatic reservation cannot be successfully made for the impromptu meeting. Additionally or instead, the feedback device 401 could indicate to the occupants that the automatic reservation has been successfully made (e.g. “An automatic reservation has been made for 15 minutes”) and/or provide information on the length of time before the next pre-booked meeting in that room (e.g. “This room is available for the next 2 hours and 20 minutes.”). A warning could also be provided towards the end of a reservation, whether pre-booked or automatic, e.g. “Your reservation expires in 5 minutes” which could be appended with “and the next reservation is in 20 minutes”. Where the automatic reservation is not successfully made, the feedback device 401 may indicate an alternative venue for the impromptu meeting (e.g. “This room is unavailable. Please use meeting room 2”).

The user feedback device 401 may be a device located in the meeting room such as a screen or bell. However, the device may be located distant from the meeting room or could be functionality which is integrated with the meeting room reservation system 101, e.g. a means for sending an email, SMS (short message service), IM (instant messenger) or pager message to the occupants of the room. The message may be received via existing equipment which is carried by the user, such as their mobile phone, computer or PDA.

The user feedback device 401 may be deactivated when the meeting room is empty.

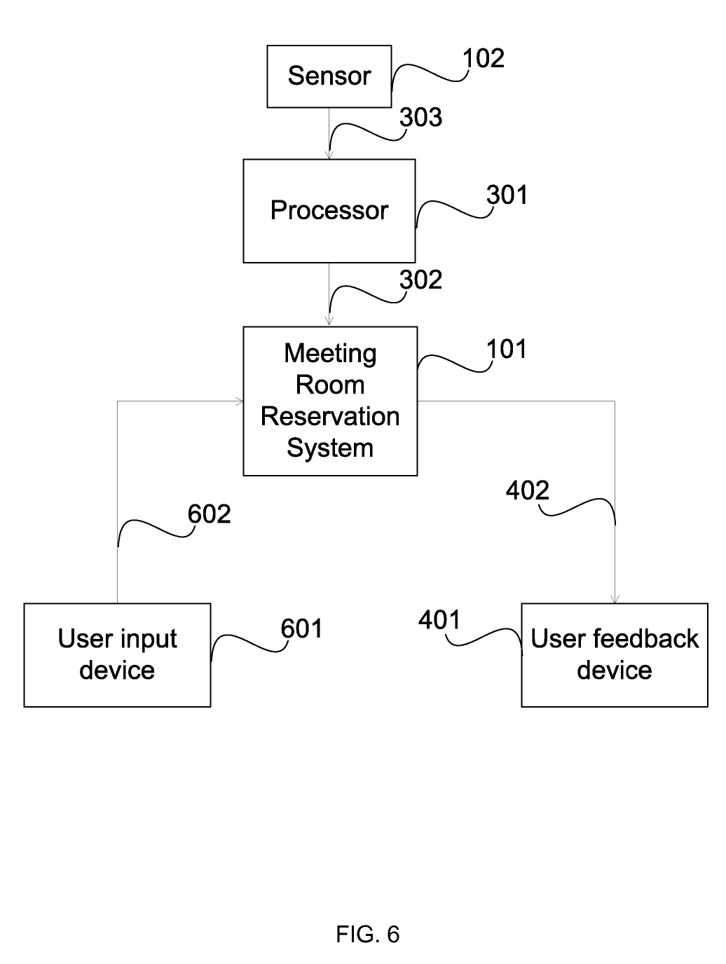

A fourth embodiment is shown in FIG. 6, which shows the same arrangement as the third embodiment with the addition of a user input device 601 connected to either the meeting room reservation system 101 (via link 602) or to the processor 301 (link not shown).

The user input device 601 may be a button, a touch screen, a keyboard or other device which enables the user of the meeting room to provide input to the meeting room reservation system 101. The user input device 601 is not necessarily located in the meeting room but capable of receiving input from the user in the meeting room. Alternatively, the user input device may not be a physical apparatus but a functional element that may be separate to or integrated with the meeting room reservation system 101. For example, the user input device may be arranged to receive a message from a user's mobile phone, computer (e.g. tablet or laptop) or PDA via SMS (short message service) or Bluetooth. Further examples of suitable input devices are detailed below.

The input device 601 is used by the occupants of the meeting room to provide additional information or requests to the meeting room reservation system 101 and examples of such information and requests are described below.
Confirmation that the meeting commencing is the pre-existing reservation and not an impromptu meeting. This may be beneficial in a scenario as shown in FIG. 5 to prevent the system from sending an alert to the room (step 504) when the system determines that the room is not free for an impromptu meeting (step 503) because of the pre-existing reservation.
Indication of length of the desired reservation. This could influence the values of X and Y (see FIGS. 2 and 5) or could result in an extra reservation being made following the initial automatic reservation for the required length of time.
Request for assistance/facilities/catering. Such a request could be for assistance with some of the facilities in the room (e.g. videoconference facilities) or for the supply of tea and coffee for the attendees of the meeting. For example, the reservation system may detect that the teleconference facilities are being activated but not functioning. In response, the reservation system may request appropriate assistance form information technology personnel, and the like. Other automatically detected facilities may include movement of furniture, use of electronic equipment, use of food preparation equipment.
Indication that the room is ready/cleared or status of a facility of the space. For some pre-booked meetings a special room configuration may have been specified (e.g. horseshoe of chairs) and once this has been set up the user input device 601 could be used to indicate this to the meeting room reservation system 101 so that the room status could be checked remotely by the meeting room facilities staff or the chairperson of the particular pre-booked meeting. Additionally, where catering has been provided it may be necessary for the room to be cleared before it can be next used. In such a case, the meeting room reservation could be automatically extended in the reservation system until an input is received from the input device 601 to confirm that the room has been cleared ready for next use.
Request for meeting reminders for reservations made in advance. Where a meeting start time passes and many required attendees have not arrived, the chairperson may request, via the input device 601, that a further meeting reminder be sent out by the meeting room reservation system 101. Such a reminder could be in the form of Outlook® reminder, email, voicemail, SMS, IM message etc. Such a request may be linked to sensing of who is actually present in the meeting room, as described in more detail below. The request might alternatively be linked to presence information relating to the required attendees of the meeting. In another example, a list of attendees or a list of non-attendees may be determined by comparing those present in the meeting room with an attendance list. The list of attendees and/or non-attendees may be used in any suitable manner, such as charging a billing system for classes attended, taking class attendance, sending meeting reminders, and the like.
Cancellation of meeting reservation. This input would cancel the remaining time on a meeting reservation, whether an advance or automatic reservation.

As the fourth embodiment shows both a user input device 601 and a user feedback device 401, the feedback device 401 may be used to acknowledge input via the input device 601. The functionality of the two devices may be combined into a single unit, and/or may be integrated into other equipment in the meeting room (e.g. projector assembly as described above). However, it will be apparent to a skilled person that an embodiment could include a user input device 601 without requiring a user feedback device 401.

The above description refers to the creation of a new automatic reservation for an impromptu meeting. The arrangements described above could also be used to extend an existing meeting reservation, irrespective of whether the reservation was an advance reservation or an automatic reservation.

When the end of an existing reservation is reached and the meeting room is still occupied, the meeting reservation may in one embodiment be extended automatically by a defined period if the meeting room is free (as in steps 506, 507, 503 and 505 in FIG. 5).

In another embodiment, when the end of an existing reservation approaches (e.g. 5 minutes before the end) and the meeting room is still occupied, the meeting reservation may be automatically extended by a defined period if free (as above). This process can be repeated until the meeting room becomes empty and then the remaining reservation time is cancelled (as in steps 506, 508 and 509 in FIG. 5).

Although the above description describes only one sensor per meeting room, it will be apparent to a skilled person that there could be more than one sensor in each room. This may be beneficial where the meeting room is large and a single sensor does not have sufficient range to sense occupants throughout the room. It may also be beneficial to include a number of sensors of different types in a room. The signals from each of these sensors can then be correlated to make the occupancy sensing more accurate or reliable (e.g. a combination of PIR sensors and detection of use of facilities/lights or a combination of a beam-break sensor on the door and a PIR sensor, as described below).

The above description refers to sensors being located in a meeting room. It will be apparent that the sensor does not necessarily have to be located in a meeting room but must be capable of performing the required occupancy sensing function in relation to the particular meeting room. The choice of location of the sensor(s) with respect to the meeting room will be dependent on the sensing technology used.

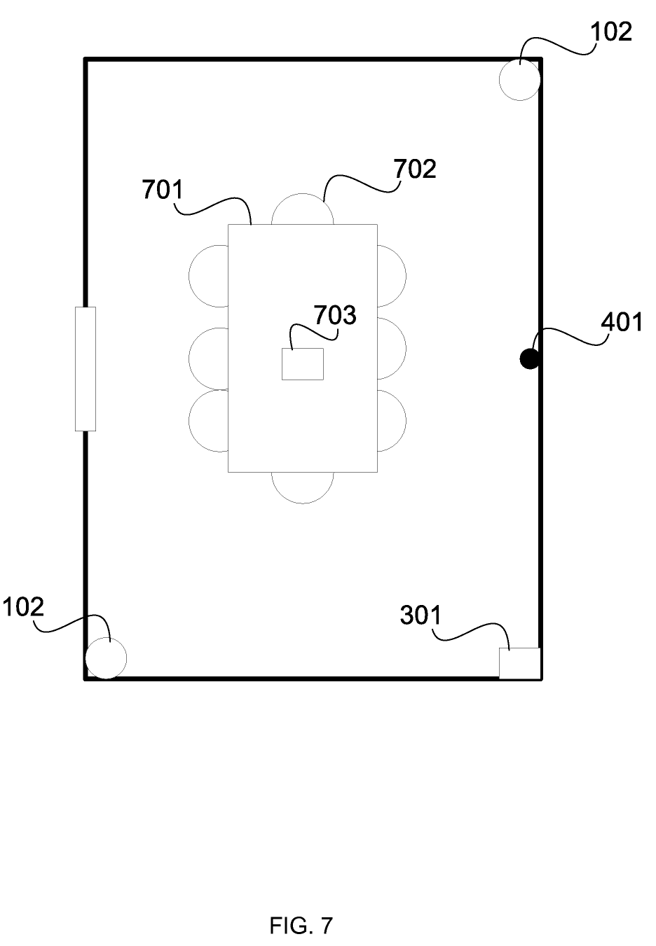

FIG. 7 shows an example meeting room layout that includes a table 701, a number of chairs 702, two sensors 102, a processor 301 and a user feedback device 401. The layout also includes a device 703 which may represent a user input device 601, a user feedback device 401 or a device such as a touchscreen which has both input and feedback functionality.

The above description refers to sensing occupancy of a room, with a room having one of two states, empty or occupied. However, by choice of suitable sensor(s) or combination of sensor(s) and processor algorithm, it is possible to sense the number of occupants in the room and/or who is in the room.

Sensing of the number of occupants in a room can be achieved using a sound sensor (e.g. a microphone) and an algorithm in the processor that can distinguish individual speech characteristics. Another option is to use a beam-break sensor on the door of the meeting room in combination with a counter algorithm within the processor, to count people in and out of the room. It may be beneficial to combine the beam-break information with information from another type of sensor, such as a PIR sensor, so that the count could be reset when the room was detected as empty by the PIR sensor, and therefore accuracy of sensing is improved. Other sensor combinations may be beneficial depending on circumstances.

The information on the number of occupants in a meeting room may be used by the reservation system 101 to influence the catering requirements for the meeting (e.g. to ensure the correct number of coffees/lunches are provided) or to influence the climate controls within the room (e.g. increase the fan speed on the air conditioning if the room is particularly full).

Sensing who is in a particular meeting room can be achieved using a RFID (radio frequency identification) reader. RFID tags may be integrated into identification badges of employees and visitors, with each tag having a unique code. When these tags are read by the RFID reader which may be located in the meeting room or be located elsewhere but able to associate tags read with location in the room, the unique codes can be used to identify the badge holders and the details of who is in the room can then be provided to the meeting room reservation system 101.

Sensing who is in a particular meeting room may also be possible through use of smart location technology which can track the location of everyone in a building or GPS (global positioning system) location technology. The sensing may be an implicit or explicit location system, e.g. Wireless Local Area Network (WLAN) or Ultrawideband (UWB) technology.

The details of who is in a meeting room may be used for the purposes of automatic attendance registers and safety systems for both automatic and advance reservations. The information may also be used to send out meeting reminders to those who have been invited to a pre-arranged meeting but are not already present in the room. Furthermore, the information could be used to determine an importance level of an impromptu meeting. Where an impromptu meeting is attended by the CEO of a company or an important visitor, the reservation may be flagged as important. This may affect how it is handled in the meeting room reservation system (e.g. cancellation or relocation of a pre-arranged meeting if the important impromptu meeting would otherwise clash).

The above description refers to a single meeting room. It will be appreciated that the meeting room reservation system 101 is likely to be managing many meeting rooms in parallel.

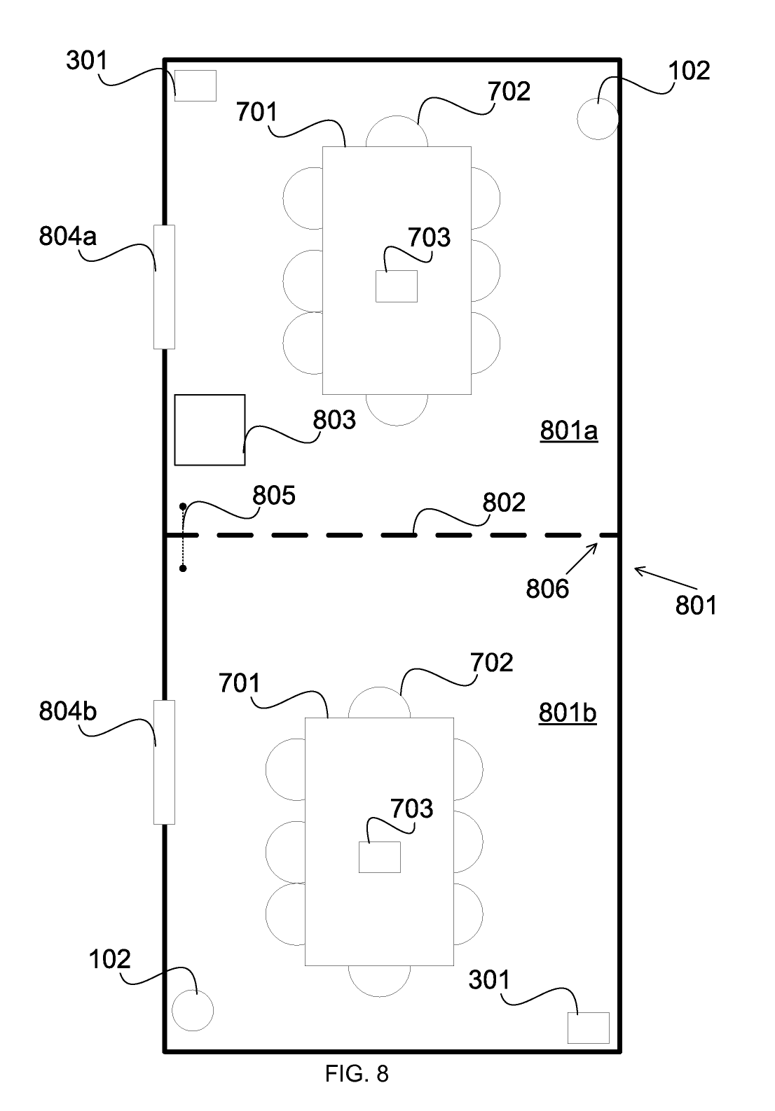

FIG. 8 shows another example layout for a large meeting room 801 that can be divided into two smaller meeting rooms 801a, 801b by means of a moveable screen 802. The rooms contain a table 701, a number of chairs 702, a sensor 102, a processor 301 and a device 703 which incorporates both the user input and the user feedback functionality. One of the two smaller rooms, 801a, also contains a television 803. Each of the smaller rooms has its own door for access 804a, 804b.

In order for a meeting room reservation system to correctly handle such a layout which may comprise one room 801 or two rooms 801a, 801b, the reservation system needs to know whether the screen 802 is in place or not. This can be achieved by use of a further sensor such as a beam-break sensor 805 or a proximity sensor between one end of the screen and the wall of the meeting room at a point 806. Such sensors can provide the meeting room reservation system with information about the layout of the room 801 and based on this information the meeting room reservation system can allow bookings of only one room 801 or two rooms 801a, 801b independently.

Additional sensor information regarding the availability of facilities, such as the television 803, chairs 702 etc may also be provided to the meeting room reservation system. This may be achieved by labeling such facilities with RFID tags and then using an RFID reader to provide an inventory to the meeting room reservation system. Such an inventory would enable the meeting room reservation system to display details of available facilities automatically to users of the reservation system and also to automatically check that any facilities which were indicated as required in an advance reservation were in a meeting room in preparation for the meeting.

Although the above description relates to meeting rooms and a meeting room reservation system, this is by way of example and the invention is not limited to just meeting rooms. The invention is applicable to other spaces or areas which may be reserved in a reservation system and may also be used in an ad-hoc manner, including, but not limited to, rooms, offices, hot desks, huddle rooms, parts of a room (e.g. parts of an open plan office), cubicles or other working areas, cages or other animal retention devices, and sports facilities (e.g. tennis courts, squash courts).

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the above description of a preferred embodiment is given by way of example only and that various modifications may be made by those skilled in the art.

1. A space reservation system comprising:
a) an input arranged to receive occupancy information relating to a space from a sensor; and
b) a processor arranged to determine a stored status of the room as either free or reserved, if the stored status indicates free and the occupancy information indicates a presence in the room, the processor being arranged to automatically update the stored status of the space as reserved, if the stored status indicates reserved and the occupancy information indicates no presence in the room, the processor being arranged to automatically update the stored status of the space as free and allow potential users of the space to reserve the space.

2. A space reservation system according to claim 1, further comprising the sensor arranged to detect occupancy in the space and provide said occupancy information to said input.

3. A space reservation system according to claim 2, wherein said sensor is one of a sound sensor, a heat sensor, a temperature sensor, a pressure sensor, a motion sensor, a location sensing system, a PIR sensor and an RFID reader.

4. A space reservation system according to claim 1, wherein said occupancy information includes information on who is present in the space, and the processor is arranged to compare who is present in the space with a meeting attendance list.

5. A space reservation system according to claim 1, wherein said processor is arranged to receive data from the sensor and to process said data to produce said occupancy information.

6. A space reservation system according to claim 5, wherein the processor includes a counter arranged to count occupants in the space.

7. A space reservation system according to claim 1, further comprising a user feedback device arranged to indicate to an occupant of said space that said space is reserved.

8. A space reservation system according to claim 7, further comprising a user feedback device arranged to indicate to an occupant of said space that said automatic reservation is about to expire.

9. A space reservation system according to claim 1, further comprising a user input device allowing a presence in the room to indicate a period of time to update the stored status of the space to reserved.

10. One or more computer readable media having computer executable components comprising:
a) based on information from a sensor, determining occupancy of a space;
b) if the occupancy information indicates that the space is occupied and a stored status of the room indicates that the space is free, updating the stored status to indicate that the room is reserved; and
c) associating with the updated stored status, that the stored status indicated reserved is an automatic reservation.

11. One or more computer readable media of claim 10, further comprising sending an alert to an occupant of the space that the automatic reservation is about to expire.

12. One or more computer readable media of claim 10, further comprising determining if a status of the space indicates that the space is free for a predetermined period of time after updating the stored status, and if the space is not free for the predetermined period of time, indicating to the occupant that the space is not free for the predetermined period of time.

13. A method of reserving a space comprising the steps of:
detecting occupancy of the space; and
if the space is occupied, automatically reserving the space in a space reservation system for a period of time; and
if the space is reserved, denying a reservation of the space by another requestor.

14. A method of reserving a space according to claim 13, wherein said step of detecting occupancy comprises at least one of a group consisting of:
detecting that the space is occupied, detecting that the space is empty, detecting that the status of the space has changed between empty and occupied, detecting who is in the space, and detecting the number of persons in the space.

15. A method of reserving a space according to claim 14, further comprising determining a status of a facility in the space, and in response to the detected status, automatically requesting assistance with the facility.

16. A method of reserving a space according to claim 13, further comprising the step of:
if the space is occupied, determining whether the space is available within the space reservation system for said period of time,
wherein said step of reserving is only performed if the space is available within the space reservation system for said period of time.

17. A method of reserving a space according to claim 16, further comprising the step of:
if the space is not available within the space reservation system for said period of time, providing feedback to an occupant of the space that a reservation could not be made.

18. A method of reserving a space according to claim 16, further comprising the step of:
if the space is not available within the space reservation system for said period of time, determining whether the space is available within the space reservation system for a shorter period of time; and
if the space is available for said shorter period of time, reserving the space for said shorter period of time.

19. A method of reserving a space according to claim 13, further comprising the step of:
detecting when the space changes from occupied to unoccupied;
if the space changes from occupied to unoccupied, checking for remaining time in a reservation; and
canceling any said remaining time in the reservation.

20. A method of reserving a meeting room according to claim 13, further comprising the step of:
at the end of said period of time, determining if said space is occupied; and
if said space is occupied, reserving the space for a further period of time.
